(19) United States
(12) Patent Application Publication
(10) Pub. No.: US 2012/0068080 A1
(43) Pub. Date: Mar. 22, 2012

(54) ION GENERATING APPARATUS

(76) Inventor: Katsushi Fujii, Osaka (JP)

(21) Appl. No.: 13/322,422

(22) PCT Filed: May 12, 2010
(86) PCT No.: PCT/JP2010/058061

§ 371 Date: Nov. 23, 2011

(30) Foreign Application Priority Data
Jun. 9, 2009 (JP) 2009-138061

(51) Int. Cl. G01T 1/16

(52) U.S. Cl. 250/393

(57) ABSTRACT

An ion generating apparatus prevents a determination that no ions are being generated even when ions are being generated. The ion generating apparatus includes: an ion generator that generates ions; an ion detector that detects generated ions; an air blower that blows the generated ions to an outside through an air supply passage; and a control section that controls driving of the ion generator and the air blower. The control section stops the air blower at a start of operation, performs ion detection using the ion detector, and determines whether ions are being generated. When the control section determines that no ions are being generated, the control section continuously performs a determination of ion generation. When the control section determines that no ions are being generated in all determinations, it is finally determined that no ions are being generated.

### TECHNICAL FIELD

The present invention relates to an ion generating apparatus having a function of detecting generated ions.

### BACKGROUND ART

In recent years, a technique of charging water molecules in air with positive ions or negative ions to clean the air in a living space has been highly used. For example, in an ion generating apparatus such as an air cleaner, an ion generator that generates positive ions and negative ions is provided at a midpoint of an air supply passage so that generated ions together with air are released to an outside space.

Ions that charge water molecules in cleaning air inactivate suspended particles in the living space, kill suspended bacteria, and denature odor components. This cleans the air in the entire living space.

A standard ion generator applies a drive voltage of high voltage AC to between a needle electrode and an opposed electrode, or between a discharge electrode and an induction electrode to generate corona discharge to generate positive ions and negative ions.

If the ion generator is operated for a long period, spatter evaporation caused by corona discharge wears a discharge electrode. Also, foreign matters such as chemical substances or dust cumulatively adhere to the discharge electrode. In such a case, discharge becomes unstable, inevitably reducing the number of generated ions.

An ion generating apparatus described in Patent Literature 1 detects whether ions are being generated or not, and notifies a user of the need to maintain the ion generator when it is detected that no ions are being generated. The ion generating apparatus includes an ion detector for detecting whether ions are being generated or not. The ion detector is provided together with the ion generator so as to face an air supply passage, the ion generator is placed on an upstream side in an air blowing direction, and the ion detector is placed on a downstream side.

### CITATION LIST

### Patent Document

Patent Literature 1: Japanese Patent Laid-Open No. 2007-114177

### SUMMARY OF INVENTION

### Technical Problem

As described above, in an ion generating apparatus, an ion generator and an ion detector are placed in parallel in an air blowing direction in an air supply passage. Positive ions and negative ions generated from the ion generator flow toward the ion detector on a leeward side by wind from an air blower. The ion detector collects and detects either positive ions or negative ions. However, since ions pass through the ion detector at a certain speed, it is difficult for the ion detector to catch the ions. Thus, even if sufficient ions are being generated, the ion detector may detect fewer ions, and erroneously detect that no ions are being generated.

In view of the above, the present invention has an object to provide an ion generating apparatus that reliably detects generated ions, and thus can prevent erroneous detection that no ions are being generated even when ions are being generated.

### Solution to Problem

The present invention provides an ion generating apparatus including: an ion generator that generates ions; an ion detector that detects generated ions; an air blower that blows out the generated ions to an outside through an air supply passage; and a control section that controls driving of the ion generator and the air blower, wherein the control section stops the air blower, performs ion detection using the ion detector, and determines whether ions are being generated or not.

When the air blower is stopped, the generated ions are not blown away. The ion detector can detect ions with high concentration immediately after being generated. Thus, when ions are being generated, the ions can be necessarily detected, thereby preventing erroneous determination that no ions are being generated even when ions are being generated.

The control section performs ion detection at a start of operation. At this time, the ion detection is performed with the air blower being stopped. Even if the air blower is not operated immediately after the start of operation, no sense of incongruity is given to a user. Further, when no ions are being generated, this can be detected at an early stage.

The control section performs ion detection at a predetermined timing during operation, and when it is detected a predetermined number of times that no ions are being generated, the control section stops the air blower and performs ion detection. The ion detection is performed a plurality of times during operation, thereby increasing determination accuracy. For final determination, the air blower is stopped to eliminate an influence of wind, and it is detected whether ions are being generated or not.

When ion detection is performed during operation, the air blower is driven. This increases possibility of erroneous determination that no ions are being generated, but performing a plurality of times of ion detection can increase determination accuracy.

When it is detected a predetermined number of times that no ions are being generated and then it is detected again that no ions are being generated, the control section determines that an ion generation error has occurred and stops operation. Final determination is performed by determining a predetermined number of times or more that no ions are being generated. Thus, erroneous determination that no ions are being generated can be reliably prevented.

The ion generator is replaceable. When a new ion generator is mounted, the control section determines suitability of the ion generator. When the ion generator is suitable, the control section allows operation of the ion generator. Since an ion generator for which it is determined that no ions are being generated cannot be used, the ion generator is replaced by a new ion generator. At this time, if an inferior ion generator is mounted, performance of the ion generating apparatus is reduced. In order to prevent this, the control section allows use of only a suitable ion generator, and for an unsuitable ion generator, the control section prohibits operation of the ion generator so that the ion generator cannot be used.

### Advantageous Effects of Invention

According to the present invention, the air blower is stopped and ions are detected, and thus generated ions are not blown away by wind, and ions with high concentration can be detected. Thus, when ions are being generated, the ions can be necessarily detected, thereby preventing erroneous determination that no ions are being generated even when ions are being generated, and increasing reliability of ion detection.

### BRIEF DESCRIPTION OF DRAWINGS

FIG. 1 is a sectional view of an ion generating apparatus of the present invention.

FIG. 2 is a block diagram showing a schematic configuration of the ion generating apparatus.

FIG. 3 is a front view of an ion generator.

FIG. 4 is a cross sectional view of the ion generator.

FIG. 5 is a front view of a collection surface of an ion detector.

FIG. 6 shows changes of an output voltage of the ion detector.

FIG. 7 is a flowchart of determination by a mode 1.

FIG. 8 is a flowchart of determination by a normal mode.

FIG. 9 is a flowchart of determination by a mode 2.

FIG. 10 is a flowchart of determination by a mode 3.

FIG. 11 is a flowchart of determination by a mode 4.

FIG. 12 is a flowchart of determination by a mode 5.

FIG. 13 is an operation flowchart of the ion generator for each mode.

FIG. 14 is an operation flowchart of an air blower for each mode.

### DESCRIPTION OF EMBODIMENTS

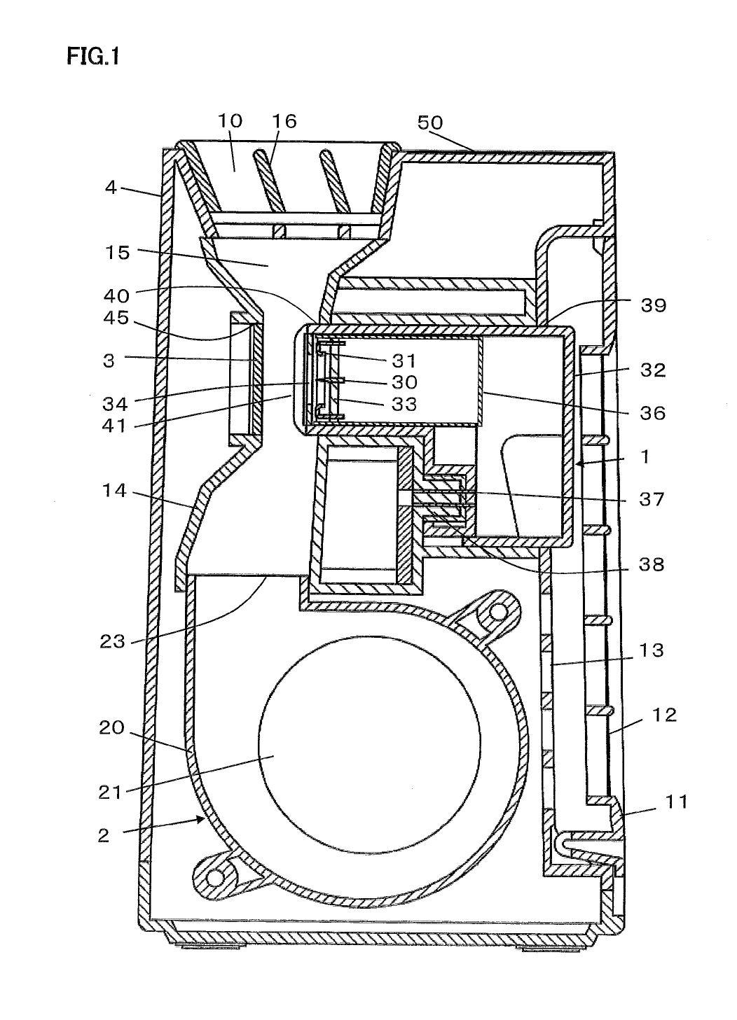

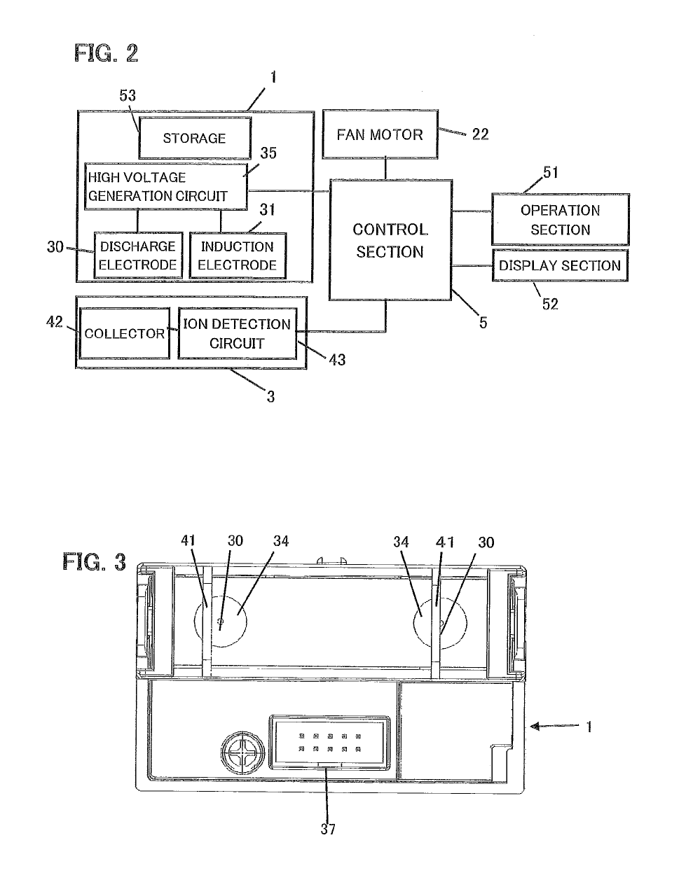

An ion generating apparatus of this embodiment is shown in FIG. 1. The ion generating apparatus includes an ion generator 1 that generates ions, an air blower 2 that blows out generated ions, and an ion detector 3 that detects the generated ions. These are housed in a body case 4. As shown in FIG. 2, the ion generating apparatus includes a control section 5 that controls driving of the ion generator 1 and the air blower 2. The control section 5 constituted by a microcomputer performs ion detection using the ion detector 3 to determine whether ions are being generated or not.

An air outlet 10 is formed in an upper surface of the body case 4, and a cover 11 is removably provided on a back surface of the body case 4. An air inlet 12 with a filter is formed in the cover 11, and an air inlet 13 is also formed in a lower portion of the back surface of the body case 4. The air blower 2 is provided in a lower portion of the body case 4, and a duct 14 is provided between the air blower 2 and the air outlet 10. An air supply passage 15 directed from the air blower 2 to the air outlet 10 is formed inside the duct 14.

The duct 14 is formed into a rectangular prism shape, and has wide upper and lower portions and a narrow intermediate portion. An outlet at an upper end of the duct 14 communicates with the air outlet 10. In the air outlet 10, a louver 16 is removably provided. The ion generator 1 and the ion detector 3 are provided on the duct 14 and face the air supply passage 15. The ion generator 1 and the ion detector 3 are placed to face each other in the narrowest intermediate portion of the air supply passage 15. Specifically, the ion generator 1 and the ion detector 3 are provided in space created by reducing the width of the duct 14. Thus, space in the body case 4 can be effectively used to reduce a size of the entire device.

The air blower 2 communicates with an inlet at a lower end of the duct 14. The air blower 2 is a sirocco fan, a fan 21 is rotatably housed in a fan casing 20, and a fan motor 22 rotates the fan 21. The fan casing 20 is mounted to the body case 4. A fan air outlet 23 is formed in an upper portion of the fan casing 20, the fan air outlet 23 is connected to the inlet of the duct 14, and the fan air outlet 23 communicates with the air supply passage 15. Air sucked through the air inlets 12 and 13 by the air blower 2 passes through the air supply passage 15 from a lower side toward an upper side, and air including ions generated from the ion generator 1 is blown out of the air outlet 10. Wind flows through the air supply passage 15 from the lower side toward the upper side, and this direction is an air blowing direction.

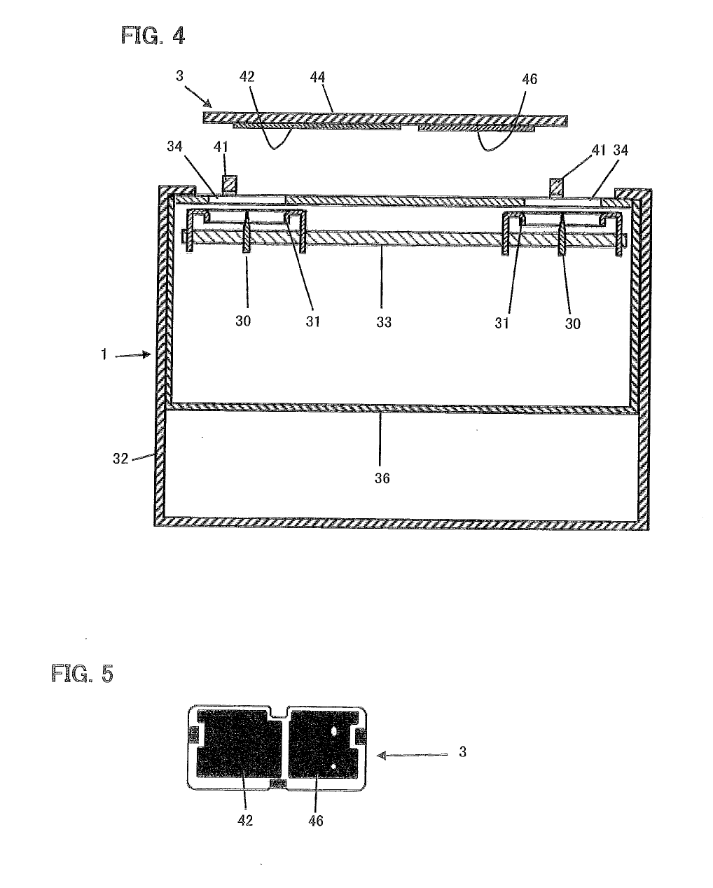

As shown in FIGS. 3 and 4, the ion generator 1 includes a discharge electrode 30, an induction electrode 31, and a housing case 32 housing the electrodes 30 and 31. The discharge electrode 30 is a needle electrode, and the induction electrode 31 is formed into an annular shape and surrounds the discharge electrode 30 at a certain distance from the discharge electrode 30. Discharge electrodes 30 and induction electrodes 31 are provided in pair on left and right and arranged in a lateral direction perpendicular to the air blowing direction, and two sets of electrodes 30 and 31 are mounted on a support substrate 33 with a space therebetween. One discharge electrode 30 is for generating positive ions and the other discharge electrode is for generating negative ions.

The support substrate 33 to which the electrodes 30 and 31 are mounted is housed in the housing case 32. Two through holes 34 are formed in a front surface of the housing case 32, and the discharge electrodes 30 face the through holes 34. The discharge electrode 30 is located at a center of the through hole 34. A high voltage generation circuit 35 that applies a high voltage to each discharge electrode 30 is provided and connected to the control section 5. The discharge electrode 30, the induction electrode 31, and the high voltage generation circuit 35 are unitized into an ion generating unit, and the ion generating unit 36 is removably mounted in the housing case 32. A pin connector 37 is provided on a front surface of the housing case 32 and connected to a socket 38 on the body case 4 side. A drive signal is input from the control section 5 through the pin connector 37 to the high voltage generation circuit 35, and DC power or AC power is supplied.

The housing case 32 is removable from the body case 4. An insertion opening 39 is formed in a back surface of the body case 4, and the housing case 32 is inserted and taken out through the insertion opening 39 with the cover 11 being removed. When the housing case 32 is inserted into the insertion opening 39, a claw formed on the housing case 32 is caught in an elastic notch formed in the body case 4, and thus the housing case 32 is mounted. A generation window 40 is formed in a wall on a back side of the duct 14, and when the housing case 32 is mounted, the housing case 32 is fitted in the generation window 40. A front surface of the housing case 32 is exposed to the air supply passage 15.

On the front surface of the housing case 32, an arch-shaped guard rib 41 is provided for each through hole 34. The guard rib 41 crosses the through hole 34. This can prevent a user from directly touching the discharge electrode 30. When the ion generator 1 is mounted to the body case 4, the guard rib 41 protrudes into the air supply passage 15 and is placed in parallel with the air blowing direction.

As shown in FIG. 3, the left and right guard ribs 41 are placed in different positions with respect to the through holes 34. Since a sucking direction and a blowing direction of the air blower 2 are different, wind blown out of the air blower 2 is offset in a lateral direction. Wind toward either of the discharge electrodes 30 is increased to lose ion balance between generated positive ions and negative ions. Thus, the guard rib 41 on a side with more wind is located closer to the center, and the guard rib 41 on a side with less wind is located on an outer side. Thus, on the side with more wind, the guard rib 41 shields a part of wind passing through a front of the through hole 34, thereby reducing an influence of offset wind, and maintaining ion balance between left and right.

When the user strongly draws the housing case 32 out of the body case 4, the notch is deformed and the pawl is disengaged, and the housing case 32 is taken out of the body case 4. The housing case 32 is openable/closable, the housing case 32 is opened and thus the ion generating unit 36 can be taken out. Thus, the ion generator 1 can be handled as a cartridge. For example, when the ion generator 1 reaches the end of its life, the ion generator 1 may be replaced by a new cartridge. If an old cartridge is disassembled to maintain the ion generating unit 36, the cartridge can be recycled and reused.

The ion detector 3 includes a collector 42 that collects generated ions, and an ion detection circuit 43 that outputs a detection signal according to the collected ions to the control section 5. As shown in FIG. 5, the conductive collector 42 is a collection electrode provided on a front surface of the circuit board 44 and is formed of copper tape. An ion detection circuit 43 is mounted to a back surface of the circuit board 44. The collector 42 and the ion detection circuit 43 are electrically connected in the circuit board 44, and the ion detection circuit 43 is connected to the control section 5 via a lead wire.

The ion detection circuit 43 is known, and as described in, for example, Japanese Patent Laid-Open No. 2007-114177, the ion detection circuit 43 is constituted by a rectifying diode, a p-MOS FET, or the like. The ion detector 3 detects either positive ions or negative ions. When the collector 42 collects either of generated positive ions or negative ions, a potential of the collector 42 increases. The potential increases depending on the number of collected ions. The ion detection circuit 43 performs A/D conversion of an output voltage according to the potential and outputs the voltage to the control section 5. The control section 5 performs determination on ion generation based on an input value from the ion detector 3.

The ion detector 3 is provided on the air supply passage 15. Specifically, the circuit board 44 is fitted in a detection window 45 formed in a wall on the front side of the duct 14. The front surface of the circuit board 44 is exposed to the air supply passage 15, and faces the front surface of the ion generator 3 with the air supply passage 15 therebetween. The collector 42 is offset toward one side in the lateral direction. The collector 42 is located in front of one discharge electrode 30 that generates one of positive and negative ions, and not located in front of the other discharge electrode 30. Thus, the collector 42 can intensively collect one of positive and negative ions.

The ion generator 1 generates positive ions and negative ions. However, the ion detector 3 may collect not only one of positive ions and negative ions to be collected but also the other. In order to prevent this possible collection, the ion detector 3 includes a protector 46. The protector 46 of a metal plate is provided on the front surface of the circuit board 44 so as to cover a part of the circuit board 44. The protector 46 is placed to face the other discharge electrode 30 that generates ions having a polarity opposite to that of the ions to be collected. The collector 42 and the protector 46 are electrically insulated. The ions generated from the other discharge electrode 30 are collected by the protector 46, and the number of ions directed toward the collector 42 is reduced, thereby preventing the ions having an opposite polarity from being collected by the collector 42.

The collector 42 is larger in size than the protector 46. As shown in FIG. 4, the collector 42 is placed so as to face the discharge electrode 30 on the left side in the drawing. Specifically, the ion detector 3 is placed closer to one discharge electrode 30 that generates ions to be collected with respect to the ion generator 1. This allows a larger number of desired ions to be collected and increases accuracy of ion detection. Further, since the guard rib 41 is offset from the center of the discharge electrode 30, generation and diffusion of ions are not interfered with, and the collector 42 can reliably collect generated ions.

A distance between the ion generator 1 and the ion detector 3 is set to a predetermined distance. Corona discharge between the discharge electrode 30 and the induction electrode 31 causes the discharge electrode 30 to generate ions. At this time, the ions spread toward the facing ion detector 3, and the ions with high concentration are distributed in a dome shape around a tip of the discharge electrode 30. If the tip of the discharge electrode 30 is too close to the facing wall of the duct 14 or the ion detector 3, discharge occurs between the discharge electrode 30 and the wall of the duct 14 or the ion detector 3. Thus, discharge becomes unstable and does not continue. Thus, the distance between the front surface of the ion generator 1 and the front surface of the ion detector 3 is set to a predetermined distance, for example, 10 mm or more so that the wall of the duct 14 or the ion detector 3 does not interfere with ion generation. The narrowest space of the duct 14 is set according to the distance. This setting allows ions to be stably generated. Also, there are ions with highest concentration immediately after being generated between the ion generator 1 and the ion detector 3, thereby allowing generation of ions to be accurately detected.

An operation panel 50 is provided on the upper surface of the body case 4, and the operation panel 50 includes an operation section 51 having an operation switch and a display section 52. When the operation switch is operated, the control section 5 drives the ion generator 1 and the air blower 2, and operates the display section 52 to display that the ion generating apparatus is being operated. In FIG. 2, reference numeral 53 denotes a rewritable nonvolatile storage element such as an EEPROM, which stores information on the ion generator 1.

When the ion generating apparatus is operated, positive ions are generated from one discharge electrode 30 of the ion generator 1, and negative ions are generated from the other discharge electrode 30. The generated ions are carried by wind blown out from below by the air blower 2, and blown out through the air outlet 10 to the outside. The released ions decompose and remove suspended mold or viruses in air.

If the ion generating apparatus is used for a long period, the discharge electrode 30 is deteriorated or dust adheres to each electrode 30 and 31, and discharge becomes unstable. This reduces the number of generated ions, and the above-described advantages cannot be obtained. Thus, the control section 5 of the ion generating apparatus integrates operating times, and when a total operating time reaches a replacement notice time, for example, 17500 hours, the control section 5 displays an indication to promote replacement of the ion generator 1. The operation is continued thereafter, but when the total operating time reaches a replacement time, for example, 19000 hours, the control section 5 determines that the ion generator 1 reaches the end of its life, stops the operation, and notifies of replacement.

However, depending on environment in which the ion generating apparatus is used, dust, moisture, oil, mist, or the like may adhere to the discharge electrode 30, and the ion generator 1 may reach the end of its life before the above-described time has passed. When the ion generator 1 reaches the end of its life, the number of generated ions is reduced or no ions are generated. The ion detector 3 detects generation of ions, and the control section 5 determines whether ions are being generated or not based on an input value from the ion generator 1. When the control section 5 determines that no ions are being generated, the control section 5 stops operation and displays an indication to replace the ion generator 1.

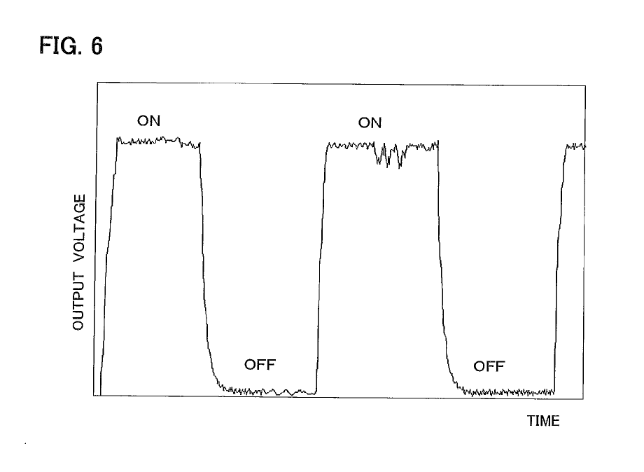

When the control section 5 performs ion detection, the control section 5 turns on the ion generator 1 for a predetermined time and then turns off for the same time. The turning on/off is repeated for a preset ion determination time. During this time, the ion detector 3 detects ions. An output voltage from the ion detector 3 at this time is shown in FIG. 6. When the ion generator 1 is on, ions are generated, and thus the output voltage increases and is saturated to a constant voltage. When the ion generator 1 is off, no ions are generated, and thus the output voltage is substantially 0 V.

An input value according to the output voltage from the ion detector 3 is input to the control section 5. The control section 5 calculates a difference between a maximum value and a minimum value of the input value detected in the ion determination time, determines whether the difference is a threshold or more, and determines whether ions are being generated or not. When the difference between the maximum value and the minimum value is the threshold or more, the control section 5 determines that ions are being generated. When the difference between the maximum value and the minimum value is the threshold or less, the control section 5 determines that no ions are being generated. The threshold is 0.5 V. This value is set based on the output voltage from the ion detector 3 when the ion generator 1 is turned on/off with the number of times of discharge at the time of decrease of ion concentration by half with respect to ion concentration in the case with a standard number of times of discharge per unit time.

Determination of ion generation is first performed at the start of operation. During the operation, the determination is performed at a predetermined timing. When the control section 5 determines a predetermined number of times that no ions are being generated, the control section 5 again performs determination, and finally determines whether an ion generation error has occurred or not. When it is determined that the ion generation error has occurred, the operation is stopped.

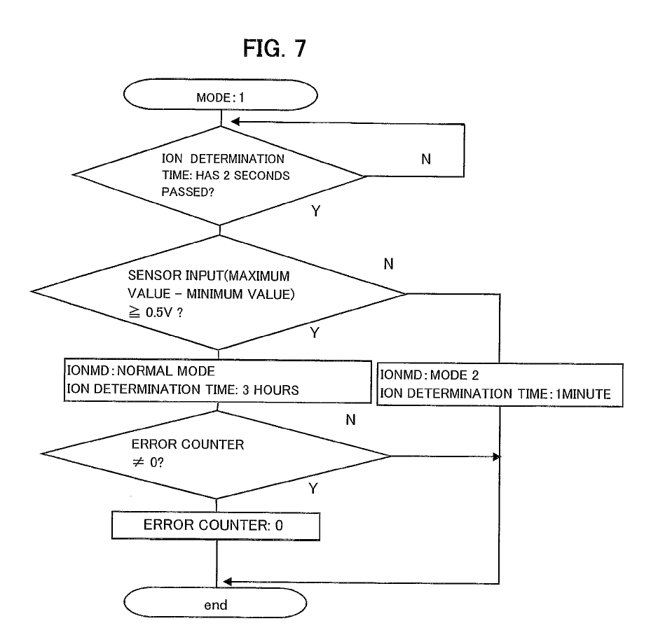

When the operation is started as described above, the control section 5 performs a plurality of times of determination of ion generation. First, at the start of the operation, the control section 5 performs determination by a mode 1. As show in FIG. 7, in the mode 1, the ion determination time is a minimum time, two seconds, the control section 5 stops the air blower 2, the ion generator 1 is turned on for 1 second and turned off for 1 second, and ion detection is performed to determine whether ions are being generated or not based on a sensor input. After the determination is finished, the control section 5 drives the air blower 2.

As such, at the start of the operation, only the ion generator 1 is driven without the air blower 2 being driven, and thus generated ions fill the narrow space between the ion generator 1 and the ion detector 3 without being blown away by wind. Specifically, since the ion generator 1 and the ion detector 3 are placed to face each other, the generated ions reach the ion detector 3 without the air blower being driven. The ion detector 3 can reliably collect the generated ions. Thus, when ions are being generated, the ions are necessarily collected, thereby preventing erroneous determination that no ions are being generated. Since the ion determination time is short, the air blower 2 is immediately driven, and no sense of incongruity is given to the user.

When the control section 5 determines in the mode 1 that ions are being generated, the control section 5 shifts to a normal mode where ion generation is not determined. The control section 5 checks whether an error counter is 0. When it is detected that ions are being generated, the error counter is reset to 0.

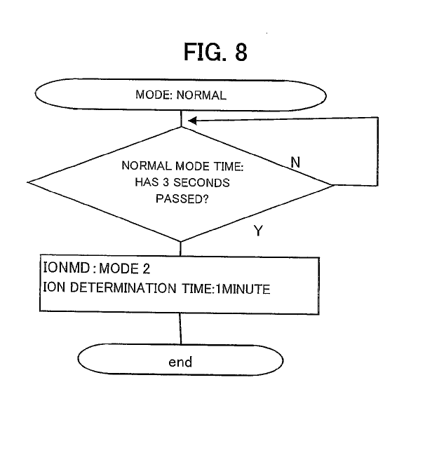

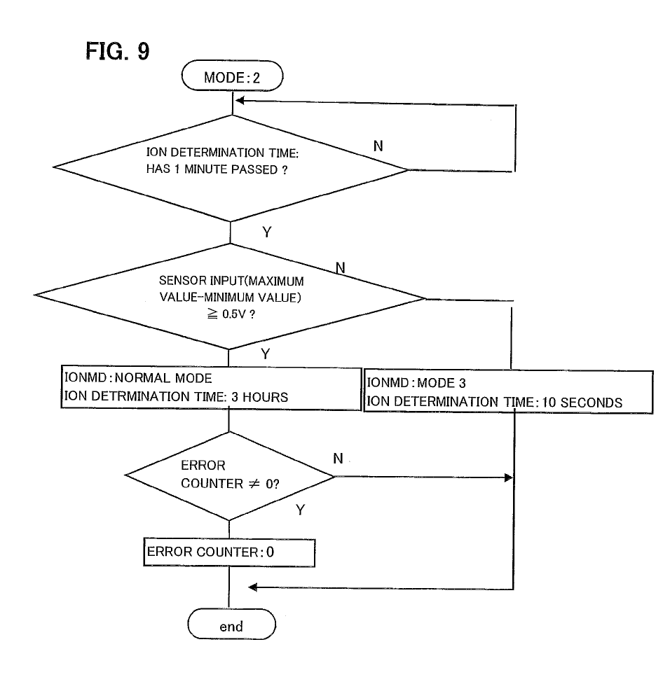

As shown in FIG. 8, in the normal mode, operation is performed for a predetermined time, for example, three hours, without determination of ion generation. When three hours have passed, the control section 5 performs determination by a mode 2. As shown in FIG. 9, in the mode 2, a longer ion determination time is set, the air blower 2 is driven, the ion generator 1 is turned on for 10 seconds and turned off for 10 seconds, and ion detection is performed for an ion determination time of 1 minute to determine whether ions are being generated or not. The ion generator 1 is turned on/off three times in 1 minute, but determination may be performed once based on a difference between a maximum input value and a minimum input value in 1 minute, or determination may be performed three times in all based on a difference between a maximum input value and a minimum input value for each tuning on/off.

When it is determined in the mode 1 that no ions are being generated, the control section 5 performs next determination by the mode 2. At this time, the mode 2 is started immediately after the determination by the mode 1. Alternatively, the mode 2 may be started several seconds after the determination by the mode 1.

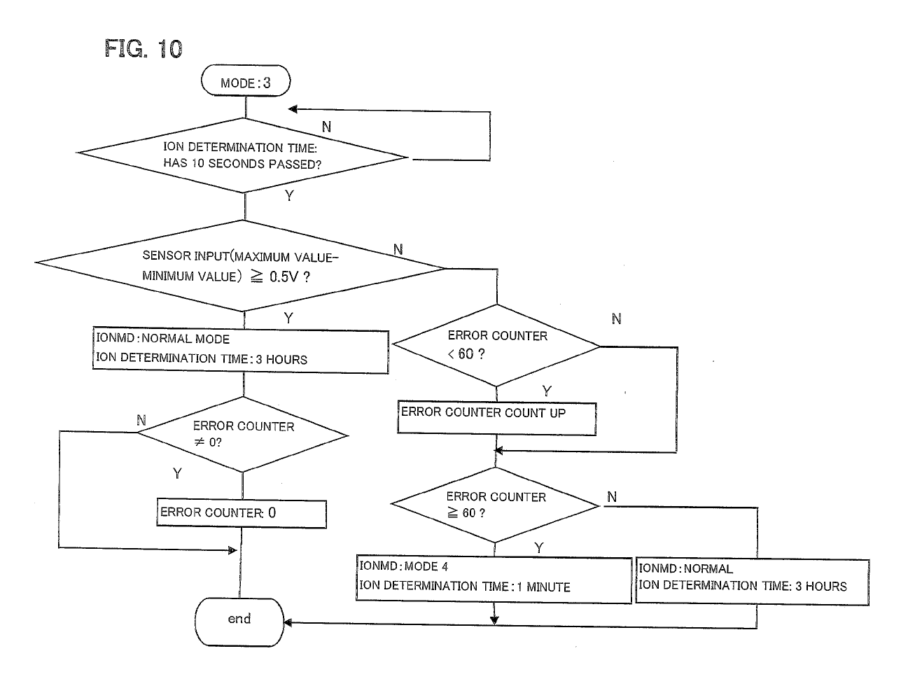

When the control section 5 determines in the mode 2 that ions are being generated, the control section 5 resets an error counter and performs the normal mode. After 3 hours have passed, the control section 5 again performs determination by the mode 2. When the control section 5 determines in the mode 2 that no ions are being generated, the control section 5 performs determination by a mode 3 immediately or within a short time. As shown in FIG. 10, in the mode 3, a shorter ion determination time is set, the air blower 2 is driven, the ion generator 1 is turned on for 1 second and turned off for 1 second, and ion detection is performed for an ion determination time of 10 seconds to determine whether ions are being generated or not. Similarly to the above, the control section 5 performs determination once based on a difference between a maximum input value and a minimum input value in 10 seconds, and determination five times in all based on a difference between a maximum input value and a minimum input value for each turning on/off.

When the control section 5 determines in the mode 3 that ions are being generated, the control section 5 resets the error counter and performs the normal mode. After 3 hours have passed, the control section 5 again performs determination by the mode 2. When the control section 5 determines in the mode 3 that no ions are being generated, the control section 5 checks whether the error counter is less than a predetermined number of times, for example, less than 60 times. When the error counter is less than 60 times, the control section 5 increments the error counter by one. When the error counter is less than 60 times, the control section 5 performs the normal mode, and performs determination by the mode 2 after 3 hours have passed. The number of times of the error counter may be appropriately set.

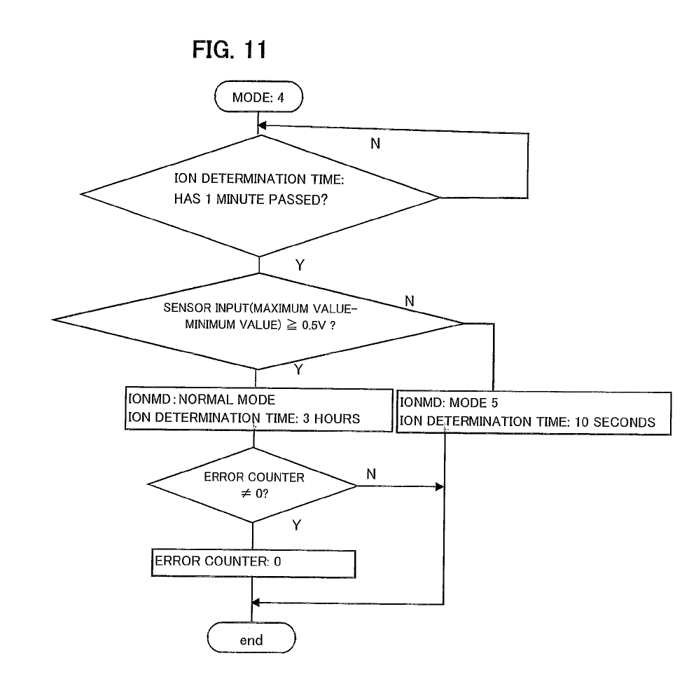

When the error counter is 60 times or more, the control section 5 performs determination by a mode 4. As shown in FIG. 11, a longer ion determination time is set in the mode 4, the air blower 2 is stopped, the ion generator 1 is turned on for 10 seconds and turned off for 10 seconds, and ion detection is performed for an ion determination time of 1 minute to determine whether ions are being generated or not similarly to the above. When the control section 5 determines in the mode 4 that ions are being generated, the control section 5 resets the error counter and performs the normal mode. After 3 hours have passed, the control section 5 again performs determination by the mode 2. When the control section 5 determines in the mode 4 that no ions are being generated, the control section 5 performs determination by a mode 5 immediately or within a short time.

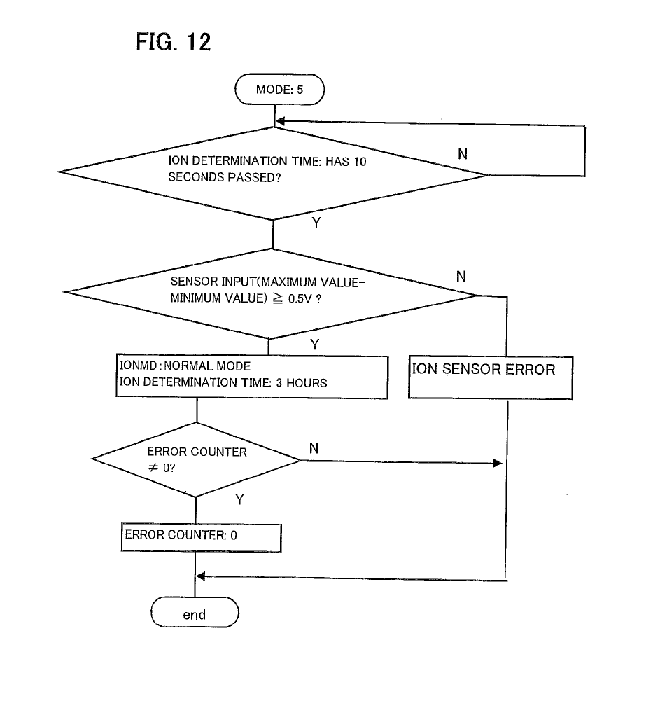

As shown in FIG. 12, in the mode 5, a shorter ion determination time is set, the air blower 2 is stopped, the ion generator 1 is turned on for 1 second and turned off for 1 second, and ion detection is performed for an ion determination time of 10 seconds to determine whether ions are being generated or not. When the control section 5 determines in the mode 5 that ions are being generated, the control section 5 resets the error counter, and performs the normal mode. After 3 hours pass, the control section 5 again performs determination by the mode 2. When the control section 5 determines in the mode 5 that no ions are being generated, the control section 5 determines that an ion generation error has occurred. The control section 5 immediately stops all loads and stops operation, and operates the display section 52 to indicate an error.

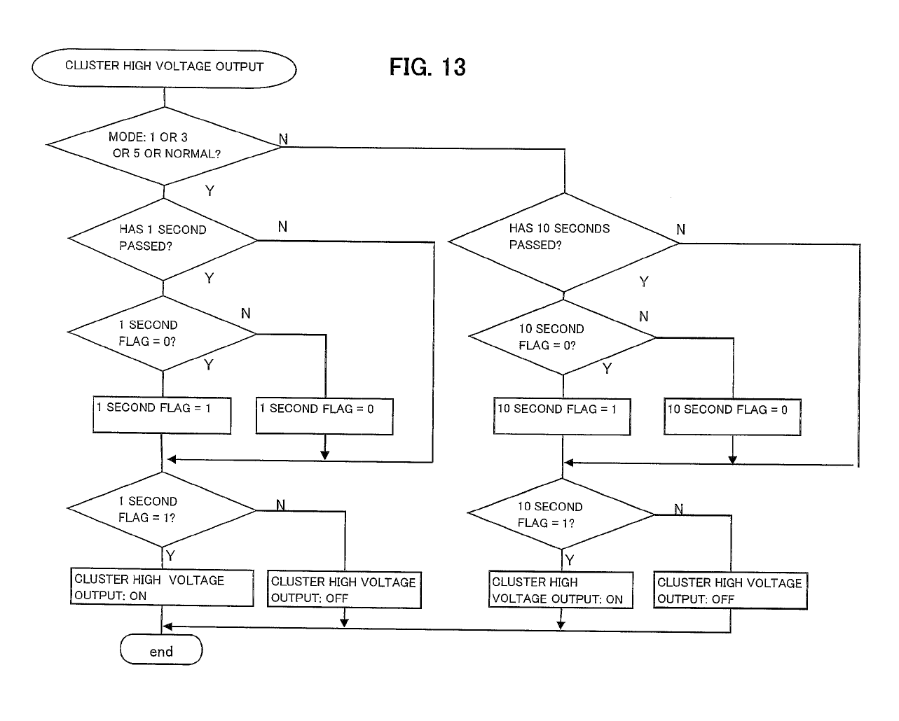

As described above, the control section 5 controls driving of the air blower 2 and the ion generator 1 depending on modes to be performed during operation including determination of ion generation. As shown in FIG. 13, when the control section 5 controls the high voltage generation circuit 35 of the ion generator 1, the control section 5 determines a mode to be performed. In the normal mode and the modes 1, 3 and 5, the driving of the high voltage generation circuit 35 is controlled by turning on 1 second and turning off 1 second. The control section 5 switches a 1 second flag to 0 or 1 every 1 second, and outputs an ON signal to the high voltage generation circuit 35 when the 1 second flag is 1 to generate ions. When the 1 second flag is 0, the control section 5 outputs an OFF signal to the high voltage generation circuit 35, and no ions are generated. In the modes 2 and 4, the driving of the high voltage generation circuit 35 is controlled by turning on 10 seconds and turning off 10 seconds. The control section 5 switches a 10 second flag to 0 or 1 every 10 seconds, and outputs an ON signal to the high voltage generation circuit 35 to generate ions when the 10 second flag is 1. When the 10 second flag is 0, the control section 5 outputs an OFF signal to the high voltage generation circuit 35, and no ions are generated.

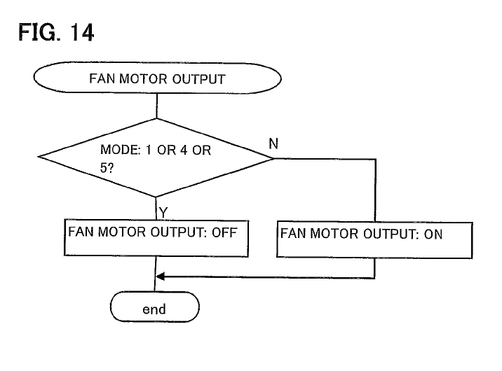

As shown in FIG. 14, when the control section 5 controls the air blower 2, the control section 5 determines the mode to be performed. In the modes 1, 4 and 5, the control section 5 outputs an OFF signal to the fan motor 22 and stops the air blower 2. In the normal mode and the modes 2 and 3, the control section 5 outputs an ON signal to the fan motor 22, and operates the air blower 2.

As described above, in the determination of whether ions are being generated or not, the air blower 2 is stopped even during operation, and thus ions are not blown away when the ions are generated, thereby allowing the ions to be reliably detected. This can eliminate erroneous determination that no ions are being generated. The ion generation is detected at the start of the operation, and thus an abnormality can be quickly sensed and then detected, thereby allowing the abnormality to be confirmed and increasing determination accuracy.

When an ion generation error occurs in the ion generating apparatus, the ion generating apparatus cannot be operated. The user removes the ion generator 1 from the body case 4 and mounts a new ion generator 1. Since the old ion generator 1 can be disassembled, the ion generating unit 36 is removed and maintenance such as cleaning of the discharge electrode 30 is performed, and thus the ion generator 1 is recycled and can be used.

Thus, a storage element 53 is provided in the ion generating unit 36 of the ion generator 1. The storage element 53 stores identification information and maintenance information such as the number of times of recycling. An information processing device such as a personal computer writes the information in the storage element 53 and reads the information. When the recycled ion generator 1 is mounted to the body case 4, the control section 5 determines suitability of the ion generator 1. Specifically, the control section 5 reads identification information from the storage element 53 of the ion generator 1. Identification information of a plurality of usable ion generators 1 is previously registered in a memory, and the control section 5 checks the read identification information against the registered information. When the identification information matches, the control section 5 recognizes that the ion generator 1 is legitimate, and allows operation of the ion generator 1. When the identification information does not match, the control section 5 determines that the ion generator 1 is not a legitimate one, and prohibits operation of the ion generator 1. Thus, only the legitimate ion generator 1 can be used, and an inferior imitation can be eliminated, thereby maintaining the function of the ion generating apparatus.

The present invention is not limited to the above-described embodiment, but various modifications and changes may be made in the embodiment within the scope of the present invention. An IC tag may be used as the storage element provided in the ion generator.

### DESCRIPTION OF SYMBOLS

1 ion generator
2 air blower
3 ion detector
4 body case
5 control section
10 air outlet
14 duct
15 air supply passage
20 fan casing
21 fan
22 fan motor
30 discharge electrode
31 induction electrode
32 housing case
34 through hole
35 high voltage generation circuit
41 guard rib
42 collector
43 ion detection circuit
46 protector

1. An ion generating apparatus comprising:
an ion generator that generates ions;
an ion detector that detects generated ions;
an air blower that blows out the generated ions to an outside through an air supply passage; and
a control section that controls driving of the ion generator and the air blower,
wherein the control section stops the air blower, performs ion detection using the ion detector, and determines whether ions are being generated or not.

2. The ion generating apparatus according to claim 1, wherein the control section performs ion detection at a start of operation.

3. The ion generating apparatus according to claim 2, wherein the control section performs ion detection at a predetermined timing during operation, and when it is detected a predetermined number of times that no ions are being generated, the control section stops the air blower and performs ion detection.

4. The ion generating apparatus according to claim 3, wherein the control section drives the air blower when performing ion detection during operation.

5. The ion generating apparatus according to claim 3, wherein when it is detected a predetermined number of times that no ions are being generated and then it is detected again that no ions are being generated, the control section determines that an ion generation error has occurred and stops operation.

6. The ion generating apparatus according to claim 1, wherein the ion generator is replaceable, and when a new ion generator is mounted, the control section determines suitability of the ion generator, and when the ion generator is suitable, the control section allows operation of the ion generator.
